(19) United States
(12) Patent Application Publication
(10) Pub. No.: US 2024/0106597 A1
(43) Pub. Date: Mar. 28, 2024

(54) METHOD AND APPARATUS FOR TRANSMITTING REFERENCE SIGNAL USING SINGLE-CARRIER OFFSET-QAM

(71) Applicant: Huawei Technologies Co., Ltd., Shenzhen (CN)

(72) Inventors: Ming Jia, Ottawa (CA); Jianglei Ma, Ottawa (CA)

(21) Appl. No.: 18/529,872

(22) Filed: Dec. 5, 2023

Related U.S. Application Data
(63) Continuation of application No. PCT/CN2021/099034, filed on Jun. 9, 2021.

(51) Int. Cl. H04L 5/00

(52) U.S. Cl. CPC H04L 5/0048; H04L 5/0073

(57) ABSTRACT

A communication method and apparatus. A set of signal outputs includes one or more reference signals including a primary reference signal defined based on a configuration parameter. The reference signals are defined to eliminate phase distortion of the primary reference signal without impacting the peak to average power ratio of a signal waveform. The primary reference signal is transmitted at a time p. The set of signal outputs may also include a second reference signal transmitted at a time p+1, and a third reference signal transmitted at a time p−1. The power level of the primary reference signal may be boosted without impacting the peak to average power ratio of the signal waveform. The primary reference signal may be a first real reference signal replacing imaginary traffic at time p or a first imaginary reference signal replacing real traffic at time p.

### CROSS-REFERENCE TO RELATED APPLICATIONS

This application is a continuation of International Application No. PCT/CN2021/099034 filed on Jun. 9, 2021, which application is hereby incorporated by reference in its entirety.

### TECHNICAL FIELD

Embodiments of the present disclosure relate generally to digital communications, and more particularly to methods and apparatuses for transmitting reference signals in communication systems using single-carrier offset quadrature amplitude modulation (SC-OQAM).

### BACKGROUND

The following is not an admission that anything discussed below is part of the prior art or part of the common general knowledge of a person skilled in the art.

Peak to Average Power Ratio (PAPR) is a signal characteristic that affects the efficiency of power amplifiers used for amplifying said signal. As power-limited communication devices use power amplifiers in the transmission of a signal, the impact of the PAPR becomes significant; as a result, it is especially beneficial to reduce the PAPR of signal waveforms used for transmissions from a power-limited device, such as uplink and sidelink transmissions in a wireless communication system.

In wireless communication systems, variations in phase and amplitude resulting from propagation across a communication channel can impact the ability of a receiver to correctly interpret the data symbols in a received signal. These variations in phase and amplitude are referred to as the channel response. The determination of the channel response of a communication channel is called channel estimation.

Orthogonal Frequency Division Multiplexing (OFDM) is a method of encoding and transmitting digital signal data, in which a single data stream is split across several subcarrier frequencies to reduce interference and cross talk. This waveform is found in the downlink of the Long Term Evolution (LTE) wireless standard.

Channel estimation in OFDM is usually performed with the aid of known pilot symbols. More particularly, at an OFDM transmitter, known pilot symbols are periodically transmitted along with data symbols. The pilot symbols are typically spaced in time and frequency. When a receiver receives an OFDM signal, the receiver compares the received value of the pilot symbols with the known transmitted value of the pilot symbols to estimate the channel response. The attenuation of the pilot symbols is measured and the attenuations of the data symbols in between these pilot symbols are then estimated and/or interpolated.

The standard OFDM waveform has a relatively large PAPR, wherein the maximum power of a sample in a given OFDM transmit symbol is large in proportion to the average power of said symbol. As a result, pilot symbols can be configured with little concern for the impact on the overall signal waveform. However, the relatively large PAPR indicates that a power amplifier using the OFDM waveform is relatively inefficient, and therefore less suitable for LTE uplink channels, which has led to the development and use of alternative lower PAPR waveforms.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

The present disclosure relates to communication methods and devices in which reference signals are transmitted as part of a set of signal output. The communication methods and devices of the present disclosure may be particularly suited to communication techniques requiring a low peak to average power ratio (PAPR). In particular, the communication methods and devices of the present disclosure may be implemented in systems using single-carrier offset quadrature amplitude modulation (SC-OQAM) techniques for wireless communications.

The communication methods and devices described herein involve reference signal configurations that enable channel data to be reliably determined without affecting the PAPR of the overall signal waveform. In particular, the communication methods and devices described herein provide reference signal configurations that account for interference from data traffic signals to a primary reference signal without impacting the PAPR of the overall waveform. The reference signal configurations described herein may also allow reference signals to be transmitted with boosted power levels while maintaining a low PAPR of the overall signal waveform. Examples of the reference signal configurations described herein may also enable a receiver to determine channel phase data from a primary reference signal, even in the absence of interference pre-cancellation. This can facilitate communication with lower complexity (e.g. low cost) transmitting devices and can also reduce signal processing complexity for transmitters more generally.

In a broad aspect of this disclosure, a communication method involves defining a set of signal outputs that includes three reference signals. A primary reference signal is defined based on a configuration parameter for the communication channel (e.g. parameters relating to channel phase data and/or amplitude data). The first reference signal is transmitted at a first signal transmission time p. Auxiliary reference signals can be transmitted immediately adjacent to the primary reference signal at times p+1 and p−1. The auxiliary reference signals can be defined to pre-cancel interference caused by data traffic signals to the first reference signal. This can ensure that the primary reference signal can be accurately measured by a receiving device.

Including two auxiliary reference signals adjacent to the primary reference signal replaces any data signals that would otherwise be transmitted immediately adjacent to the primary reference signal. This reduces the interference from data signals that needs to be pre-cancelled, albeit with a slight reduction in the data traffic that can be transmitted. Additionally, the interference pre-cancellation can be spread between the two auxiliary reference signals, reducing the power required by each individual auxiliary reference signal. This can help maintain the low PAPR of an SC-OQAM waveform.

The reduced power level of the auxiliary reference signals can be reallocated to the primary reference signal. This primary reference signal can thus be transmitted with a higher pulse power level that can enhance the performance of the primary reference signal. However, with the reduced pulse power of the auxiliary reference signals, the primary reference signal can be transmitted with this higher pulse power level without affecting the low PAPR of an SC-OQAM waveform.

In accordance with this broad aspect, there is provided a communication method comprising: obtaining a first reference signal configuration parameter; transmitting a set of signal outputs, the set of signal outputs including a first reference signal at a time p, wherein the first reference signal is defined based on the first reference signal configuration parameter, wherein the first reference signal is a first real reference signal or a first imaginary reference signal; wherein the set of signal outputs comprise a second reference signal transmitted at a time p+1, and a third reference signal transmitted at a time p−1.

In some examples, the second reference signal may be a second real reference signal at time p+1 and the third reference signal may be a third real reference signal at time p−1, where the second reference signal replaces real traffic at time p+1 and the third reference signal replaces real traffic at time p−1.

In some examples, the second reference signal may be a second imaginary reference signal at time p+1 and the third reference signal may be a third imaginary reference signal at time p−1, where the second reference signal replaces imaginary traffic at time p+1 and the third reference signal replaces imaginary traffic at time p−1.

In some examples, the second reference signal and the third reference signal may be defined to pre-cancel interference from traffic to the first reference signal.

In some examples, a pulse power of the first reference signal may be larger than a pulse power of the second reference signal and a pulse power of the third reference signal.

In some examples, the set of signal outputs can include a first real traffic signal transmitted at a time p−2 and a second real traffic signal transmitted at a time p+2.

In some examples, the set of signal outputs can include a first imaginary traffic signal transmitted at the time p−2 and a second imaginary traffic signal transmitted at the time p+2.

In some examples, the pulse power of the first reference signal may be larger than or equal to any one of the following: the pulse power of the first real traffic signal; the pulse power of the second real traffic signal; the pulse power of the first imaginary traffic signal; and the pulse power of the second imaginary traffic signal.

In some examples, any one of the pulse power of the second reference signal and the pulse power of the third reference signal is smaller than any one of the following: the pulse power of the first real traffic signal; the pulse power of the second real traffic signal; the pulse power of the first imaginary traffic signal; and the pulse power of the second imaginary traffic signal.

In some examples, the first reference signal may be a phase tracking reference signal usable for estimating the phase distortion of a communication channel.

In some examples, the first reference signal may be usable to estimate phase and amplitude-related measurements of a communication channel.

In some examples, obtaining the first reference signal configuration parameter may include receiving the first reference signal configuration parameter.

In some examples, the method may include transmitting a transmitter interference pre-cancellation capability signal prior to receiving the first reference signal configuration parameter.

In some examples, obtaining the first reference signal configuration parameter may include determining the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, the one or more operational characteristics may include the transmitter interference pre-cancellation capability, and the method may include receiving a transmitter interference pre-cancellation capability signal indicating the transmitter interference pre-cancellation capability prior to determining the first reference signal configuration parameter.

In accordance with this broad aspect, there is provided a communication method comprising: transmitting a first reference signal configuration parameter; receiving a set of signal outputs, the set of signal outputs including a first reference signal at a time p, wherein the first reference signal is defined based on the first reference signal configuration parameter, wherein the first reference signal is a first real reference signal or a first imaginary reference signal; wherein the set of signal outputs comprise a second reference signal transmitted at a time p+1, and a third reference signal transmitted at a time p−1.

In some examples, the second reference signal may be a second real reference signal at time p+1 and the third reference signal may be a third real reference signal at time p−1, where the second reference signal replaces real traffic at time p+1 and the third reference signal replaces real traffic at time p−1; or the second reference signal may be a second imaginary reference signal at time p+1 and the third reference signal may be a third imaginary reference signal at time p−1, where the second reference signal replaces imaginary traffic at time p+1 and the third reference signal replaces imaginary traffic at time p−1.

In some examples, the second reference signal and the third reference signal may be defined to pre-cancel interference from traffic to the first reference signal.

In some examples, a pulse power of the first reference signal may be larger than a pulse power of the second reference signal and a pulse power of the third reference signal.

In some examples, the set of signal outputs may include a first real traffic signal transmitted at a time p−2 and a second real traffic signal transmitted at a time p+2.

In some examples, the set of signal outputs may include a first imaginary traffic signal transmitted at the time p−2 and a second imaginary traffic signal transmitted at the time p+2.

In some examples, the pulse power of the first reference signal may be larger than or equal to any one of the following: the pulse power of the first real traffic signal; the pulse power of the second real traffic signal; the pulse power of the first imaginary traffic signal; and the pulse power of the second imaginary traffic signal.

In some examples, any one of the pulse power of the second reference signal and the pulse power of the third reference signal may be smaller than any one of the following: the pulse power of the first real traffic signal; the pulse power of the second real traffic signal; the pulse power of the first imaginary traffic signal; and the pulse power of the second imaginary traffic signal.

In some examples, the first reference signal may be a phase tracking reference signal usable for estimating the phase distortion of a communication channel.

In some examples, the first reference signal may be usable to estimate phase and amplitude-related measurements of a communication channel.

In some examples, the method may include receiving a transmitter interference pre-cancellation capability signal prior to transmitting the first reference signal configuration parameter.

In some examples, the method may include determining the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, the one or more operational characteristics may include the transmitter interference pre-cancellation capability, and the method may further include receiving a transmitter interference pre-cancellation capability signal indicating the transmitter interference pre-cancellation capability prior to determining the first reference signal configuration parameter.

In a broad aspect of this disclosure, a set of signal outputs can be defined that includes at least one reference signal. A primary reference signal can be defined based on a configuration parameter for the communication channel (e.g. configuration parameters relating to channel phase data). The set of signal outputs can be defined with an alternating pattern of real signal components and imaginary signal components. The primary reference signal can be flipped (as compared to the pattern of signal components) from real to imaginary or imaginary to real. By flipping the primary reference signal, the interference caused by data signals to the primary reference signal may not cause any phase distortion to the primary reference signal. This may allow the primary reference signal to be transmitted with increased resiliency.

In some cases, the receiver can determine channel phase data based on a flipped primary reference signal, even in the absence of interference pre-cancellation. Accordingly, the primary reference signal may be transmitted without any interference pre-cancellation. This simplifies the signal processing required at the transmitter and may facilitate communication with communication devices lacking pre-cancellation capabilities. The power level of the primary reference signal can also be increased without impacting the low PAPR of an SC-OQAM waveform.

In accordance with this broad aspect, there is provided a communication method comprising: obtaining a first reference signal configuration parameter; transmitting a set of signal outputs, the set of signal outputs including a first reference signal at a time p, wherein the first reference signal is defined based on the first reference signal configuration parameter, wherein the first reference signal is a first real reference signal replacing imaginary traffic at time p or a first imaginary reference signal replacing real traffic at time p.

In some examples, the first reference signal is the first imaginary reference signal, and the set of signal outputs can include a first real traffic signal transmitted at a time p−2 and a second real traffic signal transmitted at a time p+2.

In some examples, the first reference signal is the first real reference signal, and the set of signal outputs can include a first imaginary traffic signal transmitted at the time p−2 and a second imaginary traffic signal transmitted at the time p+2.

In some examples, the pulse power of the first reference signal may be larger than or equal to any one of the following: the pulse power of the first real traffic signal; the pulse power of the second real traffic signal; the pulse power of the first imaginary traffic signal; and the pulse power of the second imaginary traffic signal.

In some examples, the set of signal outputs can omit any signal pulses at a time p−1 and a time p+1.

In some examples, the first reference signal may be a phase tracking reference signal usable for estimating the phase distortion of a communication channel.

In some examples, obtaining the first reference signal configuration parameter may include receiving the first reference signal configuration parameter.

In some examples, the method may include transmitting a transmitter interference pre-cancellation capability signal prior to receiving the first reference signal configuration parameter.

In some examples, obtaining the first reference signal configuration parameter may include determining the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, the one or more operational characteristics may include the transmitter interference pre-cancellation capability, and the method may include receiving a transmitter interference pre-cancellation capability signal indicating the transmitter interference pre-cancellation capability prior to determining the first reference signal configuration parameter.

In accordance with this broad aspect, there is provided a communication method comprising: transmitting a first reference signal configuration parameter; receiving a set of signal outputs, the set of signal outputs including a first reference signal at a time p, wherein the first reference signal is defined based on the first reference signal configuration parameter, wherein the first reference signal is a first real reference signal replacing imaginary traffic at time p or a first imaginary reference signal replacing real traffic at time p.

In some examples, the first reference signal may be the first imaginary reference signal, and the set of signal outputs may include a first real traffic signal transmitted at a time p−2 and a second real traffic signal transmitted at a time p+2.

In some examples, the first reference signal may be the first real reference signal, and the set of signal outputs may include a first imaginary traffic signal transmitted at the time p−2 and a second imaginary traffic signal transmitted at the time p+2.

In some examples, the pulse power of the first reference signal may be larger than or equal to any one of the following: the pulse power of the first real traffic signal; the pulse power of the second real traffic signal; the pulse power of the first imaginary traffic signal; and the pulse power of the second imaginary traffic signal.

In some examples, the set of signal outputs may omit any signal pulses at a time p−1 and a time p+1.

In some examples, the first reference signal may be a phase tracking reference signal usable for estimating the phase distortion of a communication channel.

In some examples, the method may include receiving a transmitter interference pre-cancellation capability signal prior to transmitting the first reference signal configuration parameter.

In some examples, the method may include determining the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, one or more operational characteristics may include the transmitter interference pre-cancellation capability, and the method may further include receiving a transmitter interference pre-cancellation capability signal indicating the transmitter interference pre-cancellation capability prior to determining the first reference signal configuration parameter.

In a broad aspect of this disclosure, a base station comprising a transceiver and a processor may be configured to perform a communication method as described herein.

In a broad aspect of this disclosure, there is provided an apparatus comprising: at least one processor; and a non-transitory computer readable storage medium storing processor executable instructions for execution by the processor, the processor executable instructions including instructions to cause the apparatus to: obtain a first reference signal configuration parameter; and transmit a set of signal outputs using the transceiver, the set of signal outputs including a first reference signal at a time p, wherein the first reference signal is defined based on the first reference signal configuration parameter, wherein the first reference signal is a first real reference signal or a first imaginary reference signal; wherein the set of signal outputs comprise a second reference signal transmitted at a time p+1, and a third reference signal transmitted at a time p−1.

In some examples, the apparatus may further include instructions to cause the apparatus to transmit the second reference signal as a second real reference signal at time p+1 and the third reference signal as a third real reference signal at time p−1, where the second reference signal replaces real traffic at time p+1 and the third reference signal replaces real traffic at time p−1; or the apparatus may further include instructions to cause the apparatus to transmit the second reference signal as a second imaginary reference signal at time p+1 and the third reference signal as a third imaginary reference signal at time p−1, where the second reference signal replaces imaginary traffic at time p+1 and the third reference signal replaces imaginary traffic at time p−1.

In some examples, the apparatus may further include instructions to cause the apparatus to define the second reference signal and the third reference signal to pre-cancel interference from traffic to the first reference signal.

In some examples, the apparatus may further include instructions to cause the apparatus to transmit the first reference signal with a first pulse power larger than a second pulse power of the second reference signal and a third pulse power of the third reference signal.

In some examples, the apparatus may further include instructions to cause the apparatus to transmit the set of signal outputs including a first real traffic signal transmitted at a time p−2 and a second real traffic signal transmitted at a time p+2; or the apparatus may further include instructions to cause the apparatus to transmit the set of signal outputs including a first imaginary traffic signal transmitted at the time p−2 and a second imaginary traffic signal transmitted at the time p+2.

In some examples, the apparatus may further include instructions to cause the apparatus to transmit the first reference signal with a first pulse power larger than or equal to any one of the following: the pulse power of the first real traffic signal; the pulse power of the second real traffic signal; the pulse power of the first imaginary traffic signal; and the pulse power of the second imaginary traffic signal.

In some examples, the apparatus may further include instructions to cause the apparatus to transmit any one of the second reference signal and the third reference signal with a pulse power smaller than any one of the following: the pulse power of the first real traffic signal; the pulse power of the second real traffic signal; the pulse power of the first imaginary traffic signal; and the pulse power of the second imaginary traffic signal.

In some examples, the apparatus may further include instructions to cause the apparatus to transmit the first reference signal as a phase tracking reference signal used for estimating the phase distortion of a communication channel.

In some examples, the apparatus may further include instructions to cause the apparatus to define the first reference signal to be usable to estimate phase and amplitude-related measurements of a communication channel.

In some examples, the apparatus may further include instructions to cause the apparatus to obtain the first reference signal configuration parameter by receiving the first reference signal configuration parameter.

In some examples, the apparatus may further include instructions to cause the apparatus to transmit a transmitter interference pre-cancellation capability signal prior to receiving the first reference signal configuration parameter.

In some examples, the apparatus may further include instructions to cause the apparatus to obtain the first reference signal configuration parameter by determining the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, the one or more operational characteristics may include the transmitter interference pre-cancellation capability, and the apparatus may further include instructions to cause the apparatus to receive a transmitter interference pre-cancellation capability signal indicating the transmitter interference pre-cancellation capability prior to determining the first reference signal configuration parameter.

In accordance with this broad aspect, there is also provided an apparatus comprising: at least one processor; and a non-transitory computer readable storage medium storing processor executable instructions for execution by the processor, the processor executable instructions including instructions to cause the apparatus to: obtain a first reference signal configuration parameter; and transmit a set of signal outputs using the transceiver, the set of signal outputs including a first reference signal at a time p, wherein the first reference signal is defined based on the first reference signal configuration parameter, wherein the first reference signal is a first real reference signal replacing imaginary traffic at time p or a first imaginary reference signal replacing real traffic at time p.

In some examples, the apparatus may further include instructions to cause the apparatus to transmit the first reference signal as the first imaginary reference signal, and the set of signal outputs may include a first real traffic signal transmitted at a time p−2 and a second real traffic signal transmitted at a time p+2; or the apparatus may further include instructions to cause the apparatus to transmit the first reference signal as the first real reference signal, and the set of signal outputs may include a first imaginary traffic signal transmitted at the time p−2 and a second imaginary traffic signal transmitted at the time p+2.

In some examples, the apparatus may further include instructions to cause the apparatus to transmit the first reference signal with a first pulse power larger than or equal to any one of the following: the pulse power of the first real traffic signal; the pulse power of the second real traffic signal; the pulse power of the first imaginary traffic signal; and the pulse power of the second imaginary traffic signal.

In some examples, the apparatus may further include instructions to cause the apparatus to transmit the set of signal outputs omitting any signal pulses at a time p−1 and a time p+1.

In some examples, the apparatus may further include instructions to cause the apparatus to transmit the first reference signal as a phase tracking reference signal used for estimating the phase distortion of a communication channel.

In some examples, the apparatus may further include instructions to cause the apparatus to obtain the first reference signal configuration parameter by receiving the first reference signal configuration parameter.

In some examples, the apparatus may further include instructions to cause the apparatus to transmit a transmitter interference pre-cancellation capability signal prior to receiving the first reference signal configuration parameter.

In some examples, the apparatus may further include instructions to cause the apparatus to obtain the first reference signal configuration parameter by determining the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, the one or more operational characteristics may include the transmitter interference pre-cancellation capability, and the apparatus may further include instructions to cause the apparatus to receive a transmitter interference pre-cancellation capability signal indicating the transmitter interference pre-cancellation capability prior to determining the first reference signal configuration parameter.

In a broad aspect of this disclosure, there is provided a network device comprising: at least one processor; and a non-transitory computer readable storage medium storing processor executable instructions for execution by the processor, the processor executable instructions including instructions to cause the network device to: transmit a first reference signal configuration parameter; receive a set of signal outputs, the set of signal outputs including a first reference signal at a time p, wherein the first reference signal is defined based on the first reference signal configuration parameter, wherein the first reference signal is a first real reference signal or a first imaginary reference signal; wherein the set of signal outputs comprise a second reference signal transmitted at a time p+1, and a third reference signal transmitted at a time p−1.

In some examples, the second reference signal may be a second real reference signal at time p+1 and the third reference signal may be a third real reference signal at time p−1, where the second reference signal replaces real traffic at time p+1 and the third reference signal replaces real traffic at time p−1.

In some examples, the second reference signal may be a second imaginary reference signal at time p+1 and the third reference signal may be a third imaginary reference signal at time p−1, where the second reference signal replaces imaginary traffic at time p+1 and the third reference signal replaces imaginary traffic at time p−1.

In some examples, the second reference signal and the third reference signal may be defined to pre-cancel interference from traffic to the first reference signal.

In some examples, a pulse power of the first reference signal may be larger than a pulse power of the second reference signal and a pulse power of the third reference signal.

In some examples, the set of signal outputs may include a first real traffic signal transmitted at a time p−2 and a second real traffic signal transmitted at a time p+2.

In some examples, the set of signal outputs may include a first imaginary traffic signal transmitted at the time p−2 and a second imaginary traffic signal transmitted at the time p+2.

In some examples, the pulse power of the first reference signal may be larger than or equal to any one of the following: the pulse power of the first real traffic signal; the pulse power of the second real traffic signal; the pulse power of the first imaginary traffic signal; and the pulse power of the second imaginary traffic signal. In some examples, any one of the pulse power of the second reference signal and the pulse power of the third reference signal may be smaller than any one of the following: the pulse power of the first real traffic signal; the pulse power of the second real traffic signal; the pulse power of the first imaginary traffic signal; and the pulse power of the second imaginary traffic signal.

In some examples, the first reference signal may be a phase tracking reference signal usable for estimating the phase distortion of a communication channel.

In some examples, the first reference signal may be usable to estimate phase and amplitude-related measurements of a communication channel.

In some examples, the network device may further include instructions to cause the network device to receive a transmitter interference pre-cancellation capability signal prior to transmitting the first reference signal configuration parameter.

In some examples, the network device may further include instructions to cause the network device to determine the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, the one or more operational characteristics may include the transmitter interference pre-cancellation capability, and the network device may include instructions to cause the network device to receive a transmitter interference pre-cancellation capability signal indicating the transmitter interference pre-cancellation capability prior to determining the first reference signal configuration parameter.

In accordance with this broad aspect, there is provided a network device comprising: at least one processor; and a non-transitory computer readable storage medium storing processor executable instructions for execution by the processor, the processor executable instructions including instructions to cause the network device to: transmit a first reference signal configuration parameter; receive a set of signal outputs, the set of signal outputs including a first reference signal at a time p, wherein the first reference signal is defined based on the first reference signal configuration parameter, wherein the first reference signal is a first real reference signal replacing imaginary traffic at time p or a first imaginary reference signal replacing real traffic at time p.

In some examples, the first reference signal may be the first imaginary reference signal, and the set of signal outputs may include a first real traffic signal transmitted at a time p−2 and a second real traffic signal transmitted at a time p+2.

In some examples, the first reference signal may be the first real reference signal, and the set of signal outputs may include a first imaginary traffic signal transmitted at the time p−2 and a second imaginary traffic signal transmitted at the time p+2.

In some examples, the pulse power of the first reference signal may be larger than or equal to any one of the following: the pulse power of the first real traffic signal; the pulse power of the second real traffic signal; the pulse power of the first imaginary traffic signal; and the pulse power of the second imaginary traffic signal.

In some examples, the set of signal outputs may omit any signal pulses at a time p−1 and a time p+1.

In some examples, the first reference signal may be a phase tracking reference signal usable for estimating the phase distortion of a communication channel.

In some examples, the network device may include instructions to cause the network device to receive a transmitter interference pre-cancellation capability signal prior to transmitting the first reference signal configuration parameter.

In some examples, the network device may include instructions to cause the network device to determine the first reference signal configuration parameter based on one or more operational characteristics for a communication channel and/or a communication device.

In some examples, the one or more operational characteristics may include a transmitter interference pre-cancellation capability and/or an interference cancellation requirement and/or a reference signal measurement type.

In some examples, the one or more operational characteristics may include the transmitter interference pre-cancellation capability, and the network device may include instructions to cause the network device to receive a transmitter interference pre-cancellation capability signal indicating the transmitter interference pre-cancellation capability prior to determining the first reference signal configuration parameter.

In a broad aspect of this disclosure, a user equipment comprising a transceiver and a processor may be configured to perform a communication method as described herein.

In some examples, an apparatus comprising a processor and a non-transitory computer readable storage medium storing processor executable instructions for execution by the processor, the processor executable instructions including instructions to cause the apparatus to perform a communication method as described herein.

According to other aspects of the disclosure, an apparatus including one or more units for implementing any of the method aspects as disclosed in this disclosure is provided. The term “units” is used broadly refers to anything for implementing the above methods, and may alternately be known by various names, including for example, modules, components, elements, means, etc. The units can be implemented using hardware, software, firmware or any combination thereof.

It will be appreciated by a person skilled in the art that a device, method or computer program product disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

The drawings included herewith are for illustrating various examples of systems, methods, and devices of the teaching of the present specification and are not intended to limit the scope of what is taught in any way.

FIG. 1 is a diagram illustrating a simplified schematic of a communication system.

FIG. 2 is a block diagram illustrating an example of the communication system shown in FIG. 1.

FIG. 3 is a block diagram illustrating example communication system components of the communication system shown in FIG. 2.

FIG. 4 is a block diagram illustrating example modules that may be used in the communication system components shown in FIG. 3.

FIG. 5 is a plot illustrating an example set of signal outputs that may be transmitted by a communication device.

FIG. 6 is a plot illustrating an example set of signal outputs that may be transmitted by a communication device illustrating an example reference signal configuration in accordance with a first embodiment.

FIG. 7 is a plot illustrating an example set of signal outputs that may be transmitted by a communication device illustrating an example reference signal configuration in accordance with a second embodiment.

FIG. 8 is a plot illustrating an example set of signal outputs that may be transmitted by a communication device illustrating an example reference signal configuration in accordance with a third embodiment.

FIG. 9 is a flowchart illustrating an example communication method that may be implemented by a communication device transmitting a reference signal.

FIG. 10 is a flowchart illustrating an example communication method that may be implemented by a communication device receiving a reference signal.

FIG. 11 is a flowchart illustrating an example communication method that may be implemented by a first communication device.

FIG. 12 is a flowchart illustrating an example communication method that may be implemented by a second communication device.

FIG. 13 is a flowchart illustrating an example communication method that may be implemented by the first communication device.

FIG. 14 is a flowchart illustrating an example communication method that may be implemented by the second communication device.

### DETAILED DESCRIPTION OF ILLUSTRATED EMBODIMENTS

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present disclosure(s),” unless expressly specified otherwise.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object-oriented programming. Accordingly, the program code may be written in C, C++ or any other suitable programming language and may comprise modules or classes, as is known to those skilled in object-oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

A computer program is a group of instructions that can be executed by a computer (i.e. by a processor). A process is an instance of a program, i.e. a copy of a program in computer memory that is ready to be executed by the computer's central processing unit(s) (CPUs). In the discussion that follows, reference is made to a processor of a computer system and operations performed by the processor of a computer system. It should be understood that such references encompass one or more processing elements and the use of one or more processing elements to perform operations, such as one or more processing cores within one or more CPUs.

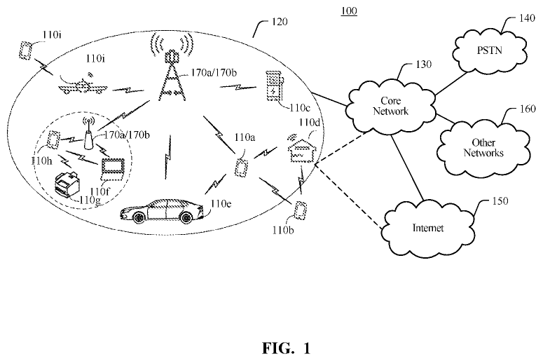

Referring to FIG. 1, as an illustrative example without limitation, a simplified schematic illustration of a communication system is provided. FIG. 1 illustrates an example communication system 100 in which embodiments of the present disclosure could be implemented.

The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

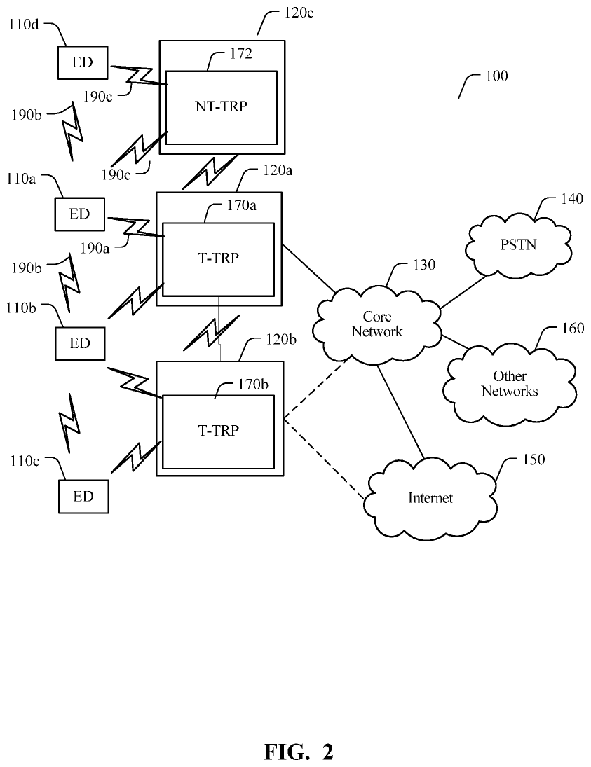

FIG. 2 illustrates a further example of the communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

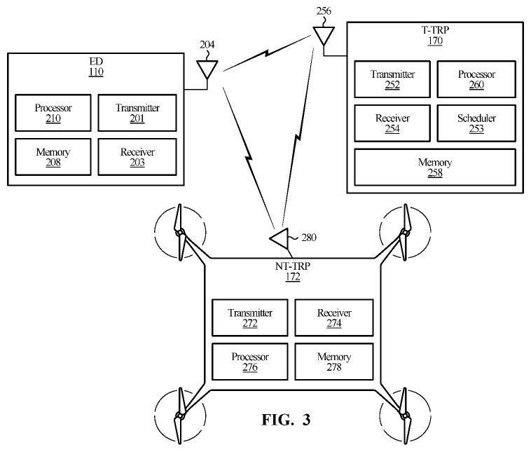

FIG. 3 illustrates another example of an ED 110, a base station 170a, 170b and/or 170c and an access node 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, an NT-TRP access node will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

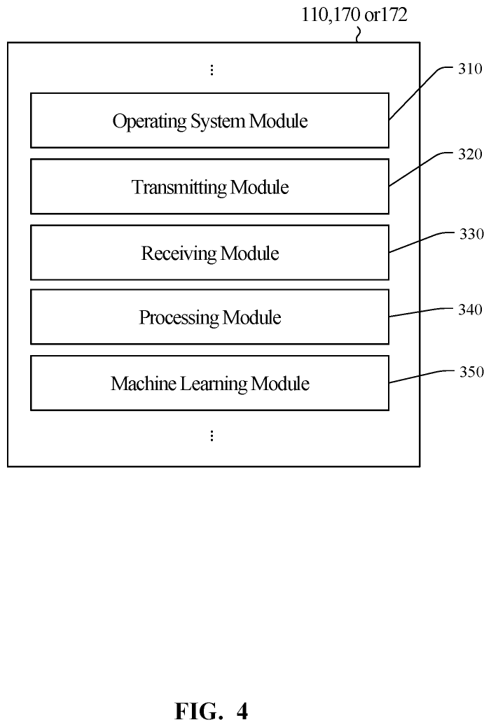

One or more steps of the embodiment methods provided herein may be performed by corresponding units or modules as shown in the example of FIG. 4. FIG. 4 illustrates examples of units or modules in a device, such as in ED 110, in T-TRP 170, or in NT-TRP 172. For example, a signal may be transmitted by a transmitting unit or a transmitting module 320. A signal may be received by a receiving unit or a receiving module 330. A signal may be processed by a processing unit or a processing module 340. Other steps may be performed by an artificial intelligence (AI) or machine learning (ML) module 350. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation. It will also be appreciated that modules implemented using software may be implemented within an operating system provided by operating system module 310.

Additional details regarding the EDs 110, T-TRP 170, and NT-TRP 172 are known to those of skill in the art. As such, these details are omitted here.

Existing communications systems use reference signals, also referred to as pilot symbols, to determine the channel response of a communication channel. The variations in phase and amplitude resulting from propagation across a communication channel are referred to as the channel response. The channel response can be frequency and time dependent. If a receiver can determine the channel response, the received signal can be corrected to compensate for the channel degradation. The determination of the channel response is called channel estimation. The transmission of reference signals (e.g. known pilot symbols) along with traffic signals (e.g. data symbols) allows the receiver to carry out channel estimation.

Channel estimation in OFDM is usually performed with the aid of known pilot symbols which are sparsely inserted in a stream of data symbols. More particularly, at an OFDM transmitter, known pilot symbols are periodically transmitted along with data symbols. The pilot symbols are typically spaced in time and frequency. When a receiver receives an OFDM signal, the receiver compares the received value of the pilot symbols with the known transmitted value of the pilot symbols to estimate the channel response. The attenuation of the pilot symbols is measured and the attenuations of the data symbols in between these pilot symbols are then estimated/interpolated.

Typically, pilot symbols are considered overhead and systems are designed to minimize the number of pilot symbols as much as possible in order to maximize the transmission rate of data symbols. Thus, systems are generally designed so that channel estimation in OFDM can be as accurate as possible without sacrificing bandwidth. As a result, the power allocated to reference signals may be increased to ensure that maximal bandwidth can be maintained.

In wireless communication systems that employ OFDM, a transmitter transmits data to a receiver using many sub-carriers in parallel. The frequencies of the sub-carriers are orthogonal.

In OFDM/OQAM, each subcarrier carries real and imaginary data symbols (e.g. alternating real-valued symbols and imaginary-valued symbols) at a double Nyquist rate. Single carrier offset-QAM (SC-OQAM) is a special case of OFDM/OQAM in which only a single carrier is used.

SC-OQAM operates with a real/imaginary signal pulse-offset in the time domain. In this configuration, signals are transmitted in a sequence of alternating real-valued symbol signals (referred to herein as real signals) and imaginary-valued symbol signals (referred to herein as imaginary signals). The signals in SC-OQAM are typically transmitted at twice the Nyquist rate. As a result, while adjacent real-valued symbol signals and imaginary-valued symbol signals may interfere with one another, pairs of subsequent real-valued symbol signals (or pairs of subsequent imaginary-valued symbol signals) are spaced apart at the Nyquist rate, avoiding interference between these signals.

SC-OQAM can be transmitted with a low-PAPR waveform that is desirable for many different communication applications, such as satellite communication, mmWave backhaul, integrated communication and sensing, IoT, and 6G for example. For example, in the millimeter-wave (mmWave) frequency range, low PAPR is a highly desirable property due to the challenges associated with RF components. However, phase-noise can also be severe in many applications of SC-OQAM (such as mmWave frequency range) and must be addressed.

In 3GPP, there are existing phase-tracking reference signal (PT-RS) designs for waveforms that are orthogonal in the complex domain (i e where each pulse can be a complex valued QAM symbol). In these situations, PT-RS design is relatively straightforward. In SC-OQAM, however, data pulses are only orthogonal in the real domain. However, to maintain this real-domain orthogonality for data pulses, proper channel estimation is required.

As shown below, PT-RS suffers from interference due to neighboring real-valued data signals (referred to herein as real data signals and/or real traffic signals) and imaginary-valued data signals (referred to herein as imaginary data signals and/or imaginary traffic signals) in SC-OQAM systems. However, for many applications, it is necessary that reference signals (such as PT-RS) be interference free to ensure that the receiving device can perform channel estimation accurately. Thus, it is necessary to account for the interference caused by neighboring data signals when transmitting reference signals in SC-OQAM systems.

Since SC-OQAM transmits data pulses at the double of the Nyquist rate, there will be interference among neighboring data. Assuming a filter with an overlapping factor K=4, the impulse response of an SC-OQAM transmission system operating at twice the Nyquist rate is shown in Table 1:

TABLE 1
Impulse response of a filter bank transmission system (K = 4)

| time | p − 4 | p − 3 | p − 2 | p − 1 | p | p + 1 | p + 2 | p + 3 | p + 4 |
|---|---|---|---|---|---|---|---|---|---|
| interference | 0 | −.067 | 0 | 0.564 | 1 | 0.564 | 0 | −.067 | 0 |

In Table 1, the pulse at time p is the pulse of interest (in the context of this disclosure, the primary reference signal). Since SC-OQAM transmits signals at a double Nyquist rate, pulses at time p−1 and p+1 have high interference ‘0.564’ on the pulse at time p. On the other hand, since pulses at time p−2 and p+2 are at a Nyquist rate with respect to the pulse at time p, their interferences on the pulse at time p is ‘0’. Similar explanations apply to the pulses at time p−3 and p+3, as well as p−4 and p+4. Beyond that range, interferences from further-away pulses on the pulse at time p are even smaller and will be disregarded for the purpose of enhancing clarity (although they may be considered in actuality by signal processing systems implementing the embodiments described herein).

From Table 1 it can be shown that transmitting real signals at time p, p±2, and p±4 will result in no interference between these signals. On the other hand, transmitting imaginary signals at time p±1 and p±3 will result in interference on a real signal at time p. Since the imaginary signals introduce imaginary valued interference on the real signal at time p, however, the real valued part of the received signal can be retrieved while discarding the imaginary part, and thus the intended signal can be retrieved. This is the “real-domain orthogonality” implemented in SC-OQAM systems. The same real-domain orthogonality can be applied to transmitted imaginary signals as well, for instance if the signals at time p, p±2, and p±4 are imaginary, and the signals at time p±1 and p±3 are real, the signals at time p±1 and p±3 cause real valued interferences to the signal at time p, and thus can be discarded as well (i.e. only the imaginary valued portion of the signal received at time p need be evaluated, thus negating the impact of the real valued interferences).

To separate the real signals and imaginary signals in SC-OQAM, channel information is required in order to remove amplitude and phase distortion caused by the channel. Unfortunately, channel state is complex and thus “real-domain orthogonality” is not applicable to channel estimation. As a result, any interference to a primary reference signal intended for use in channel estimation will be reflected as part of the channel.

Similar to SC-OQAM, modulated signals in OFDM/OQAM are only orthogonal in the real-domain. Accordingly, the demodulation reference signal (DM-RS) design in OFDM/OQAM (like in SC-OQAM) is different from that used in systems with waveforms that are orthogonal in the complex domain. To allow a receiver to estimate the channel, reference signals (e.g. pilot symbols) need to be interference free. Accordingly, in existing OFDM/OQAM communication systems, an auxiliary reference signal (or auxiliary pilot symbol) may be used to pre-cancel the interference, on the presumption that the channel is constant between the reference signal and the interfering data signal(s).

To avoid interfering with the data signals, a reference signal transmitted at time p is sent as a real reference, where data signals transmitted at time p±3 are imaginary data signals. In addition, an imaginary auxiliary RS sent at time p−1 or p+1 can be used to pre-cancel the interference from imaginary data. While the interference from the data signals to the primary reference signal is data dependent, it can be calculated prior to transmission and then pre-cancelled using the auxiliary RS.

Referring to FIG. 5, shown therein is a first set of signal outputs 400. The first set of signal outputs 400 illustrates an example of a reference signal configuration used in existing OFDM/OQAM communication systems. The set of signal outputs 400 may be transmitted by a communication device such as an ED 110 and/or a base station (e.g. T-TRP 170) for example.

The first set of signal outputs 400 are illustrated over a time interval t. The time interval t can include a plurality of potential signal component times (e.g. p−3, p−2, p−1, p, p+1, p+2, p+3 . . . ) that are equally spaced apart in time. The signal outputs in the first set of signal outputs 400 can be transmitted as signal pulses located at the potential signal component times within the time interval t.

As shown in FIG. 5, the set of signal outputs 400 include a first reference signal 430 (also referred to herein as a primary reference signal and/or pilot signal). The first reference signal 430 can be configured to provide a receiver with information relating to the channel between the transmitter and the receiver. For example, the first reference signal 430 may be defined as a pilot symbol usable for channel estimation. The first reference signal 430 can be defined using configuration parameters exchanged between the transmitter and the receiver. The first reference signal 430 may be known in advance by the transmitter and receiver. This can allow the receiver to detect variations in the received reference signal in order to evaluate the channel response between the transmitter and the receiver.

As illustrated, the first reference signal 430 is transmitted at a time p (i.e. at a potential signal component time p). In the example illustrated in FIG. 5, a second reference signal 440 (also referred to herein as a first auxiliary reference signal and/or first interference pre-cancellation signal) is also included in the set of signal outputs 400. This auxiliary reference signal 440 is defined to pre-cancel interference from nearby data traffic signals to the primary reference signal 430. As illustrated, the second reference signal 440 is provided at the potential signal component time p+1. Alternately, the second reference signal 440 may be provided at the potential signal component time p−1.

As shown in FIG. 5, the set of signal outputs 400 can also include a plurality of traffic signal components 410/420. The traffic signal components 410/420 can be defined based on data to be transmitted from the transmitting device to a receiving device. The plurality of traffic signal components can include a sequence of alternating real traffic signals 410a-410c (referred to generically as real traffic signals 410) and imaginary traffic signals 420a-420c (referred to generically as imaginary traffic signals 420).

In a communication system using OFDM/OQAM, the signals in the set of signal outputs 400 are orthogonal in the real domain. As a result, once channel information is properly estimated, the received real traffic signals 410 and imaginary traffic signals 420 can be readily distinguished. As a result, accurate channel estimation is required to ensure that real-domain orthogonality can be maintained. The first reference signal 430 can be defined to allow the receiving device to perform channel estimation. However, the traffic signals 410/420 can cause interference with the first reference signal 430.

In conventional OFDM/OQAM reference signal configuration (such as illustrated in FIG. 5), the auxiliary reference signal 440 is used to pre-cancel the interference from data signals 420 to the primary reference signal 430 (in the example illustrated, the data signals 410 do not interfere with the primary reference signal 430). This can help ensure that the first reference signal 430 can be properly interpreted by the receiving device.

As shown in Table 1 above, the first reference signal 430 experiences interferences from multiple nearby data signals, in particular the imaginary traffic signal 420b at time p−1, the imaginary traffic signal 420a at time p−3, and the imaginary traffic signal 420c at time p+3. Thus, the auxiliary reference signal 440 is required to pre-cancel interference from the imaginary traffic signals 420a-420c (and in some cases, more minor interference from additional traffic signals further from the primary reference signal 430).

This approach results in a data dependent power variation in the auxiliary reference signal 440, which in turn affects the PAPR of the waveform. In addition, since interference pre-cancellation is data dependent, there may exist residual interference when a long duration filter is used.

The set of signal outputs 400 shown in FIG. 5 illustrates an example of a conventional reference signal design in a communication system using OFDM/OQAM. In the example illustrated, the first reference signal 430 is a real reference signal that replaces a real data traffic signal component (i.e. the first reference signal 430 is a real reference signal located at a potential signal component time p that would otherwise be used to transmit a real traffic signal component). Alternately, where the first reference signal 430 is located at a potential signal component time that would otherwise be used to transmit an imaginary traffic signal component (e.g. where the data signals 410 are imaginary traffic signals and the data signals 420 are real traffic signals), the first reference signal 430 is an imaginary reference signal that replaces an imaginary data traffic signal component.

In the example illustrated, the second reference signal 440 is an imaginary reference signal that replaces an imaginary data traffic signal component (i.e. the second reference signal 440 is an imaginary reference signal located at a potential signal component time p+1 that would otherwise be used to transmit an imaginary traffic signal component). Alternately, where the second reference signal 440 is located at a potential signal component time that would otherwise be used to transmit a real traffic signal component (e.g. where the data signals 410 are imaginary traffic signals and the data signals 420 are real traffic signals), the second reference signal 440 is a real reference signal that replaces a real data traffic signal component.

To cancel all the interferences from nearby data signals, the power used by the second reference signal 440 may be larger than that of a normal data signal 410/420. As a result, the auxiliary reference signal 440 may impact the PAPR of the waveform. In the example illustrated, a signal output pulse is transmitted at each potential signal component time. Although, the increased power of the second reference signal can result in a larger power peak, in communication systems using OFDM/OQAM, the PAPR of the set of signal outputs fortunately does not need to be considered in the reference signal design because the power peak of the reference signal contributes little to the overall signal PAPR when considering the multi-carrier data.

By contrast, in SC-OQAM, it is crucial to maintain the low PAPR property of the waveform (i.e. for the set of signal outputs). As a result, the conventional reference signal designs for OFDM/OQAM cannot be used directly for SC-OQAM, as they will typically result in higher PAPR. In addition, power optimization of the phase-tracking reference signal configuration for SC-OQAM is also constrained by the requirement to maintain a low PAPR. That is, a channel estimation (e.g. phase-tracking) reference signal for a SC-OQAM system must be configured to enable a low PAPR SC-OQAM waveform.

Referring to FIG. 6, shown therein is a second set of signal outputs 500. The set of signal outputs 500 illustrates an example of a first reference signal configuration in accordance with a first embodiment. The first reference signal configuration may be particularly suited to use in communication systems requiring low PAPR waveforms, such as communication systems using SC-OQAM.

As with the first set of signal outputs 400, the second set of signal outputs 500 are also illustrated over a time interval t. The set of signal outputs 500 is generally similar to the first set of signal outputs 400 shown in FIG. 5 with the exception of the signal pulses transmitted at p−1 and p+1, and in some cases the signal pulse at time p.

As shown in FIG. 6, the second set of signal outputs 500 includes a primary reference signal 530 (also referred to herein as a first reference signal) Similar to the first reference signal 430, the first reference signal 530 can be configured to provide a receiver with information relating to the channel between the transmitter and the receiver. For example, the first reference signal 530 may be defined as a pilot symbol usable for channel estimation. The first reference signal 530 can be defined using configuration parameters exchanged between the transmitter and the receiver. As illustrated, the primary reference signal 530 is transmitted at a time p (i.e. at a potential signal component time p).

As with OFDM/OQAM, the data signals in SC-OQAM are also orthogonal in the real domain. Accordingly, once channel information is established, received real data signals and imaginary data signals can be distinguished. Accordingly, ensuring accurate interpretation of reference signals in the SC-OQAM transmission is essential to ensuring proper communication. However, the primary reference signal 530 will experience interference from neighboring data signals. Accordingly, it becomes necessary to account for that data signal interference in order to avoid phase distortion of the primary reference signal that could cause a loss of real-domain orthogonality at the receiver.

Similar to the first set of signal outputs 400, the second set of signal outputs 500 includes an auxiliary reference signal 540b at potential signal component time p+1. However, rather than including only one auxiliary pilot signal (as was the case with the set of signal outputs 400), the set of signal outputs 500 includes an additional auxiliary reference signal 540a (also referred to herein as a third reference signal and/or a second auxiliary reference signal and/or a second interference pre-cancellation signal) at potential signal component time p−1.

As shown in FIG. 6, the auxiliary reference signals and primary reference signals can be transmitted at three consecutive signal component times (p−1, p, p+1). The middle signal component time p can be used to transmit the primary reference signal 530. The immediately adjacent signal component times (p−1, p+1) on either side of the primary reference signal 530 can be used to transmit the auxiliary reference signals 540a/540b.

The auxiliary reference signals 540a/540b can be defined to pre-cancel interference from the data signals 420 to the primary reference signal 530 (in the example illustrated, the data signals 410 do not interfere with the primary reference signal 530). The transmitter can be configured to determine expected traffic signal interference between the plurality of traffic signals 410/420 and the primary reference signal 530. The transmitter can then define the auxiliary reference signals 540a/540b as a pair of pre-cancellation signals determined to cancel the expected traffic signal interference for the primary reference signal 530.

By replacing the data signals at p−1 and p+1 with auxiliary reference signals 540a/540b, the power required by the auxiliary reference signals 540a/540b for interference pre-cancellation can be significantly reduced (i.e. the interference that would otherwise be caused by a data signal at p−1 or p+1 is eliminated). This can help maintain the low PAPR of the overall SC-OQAM waveform.

In addition, because the interference pre-cancellation is spread across two auxiliary reference signals 540a and 540b, the amount of interference pre-cancellation required for each auxiliary reference signal 540 is further reduced. This may allow the auxiliary reference signals 540a and 540b to be transmitted with reduced power. This, in turn, lowers the combined pulse power level at the first reference signal 530 transmission location p.

For example, the pulse power of the auxiliary reference signal 540a and/or auxiliary reference signal 540b may be smaller than the pulse power of the traffic signal 410a (in this example, a real traffic signal) and/or the pulse power of the traffic signal 420a (in this example, an imaginary traffic signal) and/or the pulse power of the traffic signal 410b (in this example, a real traffic signal) and/or the pulse power of the traffic signal 410c (in this example, a real traffic signal) and/or the pulse power of the traffic signal 420c (in this example, an imaginary traffic signal). In some examples, the pulse power of the auxiliary reference signal 540a and/or auxiliary reference signal 540b may be smaller than the average power level of the traffic signals 410/420.

In some examples, the pulse power of the first reference signal 530 may be boosted without affecting the PAPR of the overall waveform. For example, the pulse power of the first reference signal 530 may be larger than the pulse power of the second reference signal 540a and the pulse power of the third reference signal 540b.

The pulse power of the first reference signal 530 may also be increased to be equal to, or greater than, the pulse power of data signals in the second set of signal outputs 500. For example, the pulse power of the first reference signal 530 may be larger than or equal to the pulse power of the traffic signal 410a (in this example, a real traffic signal) and/or the pulse power of the traffic signal 420a (in this example, an imaginary traffic signal) and/or the pulse power of the traffic signal 410b (in this example, a real traffic signal) and/or the pulse power of the traffic signal 410c (in this example, a real traffic signal) and/or the pulse power of the traffic signal 420c (in this example, an imaginary traffic signal). In some examples, the pulse power of the first reference signal 530 may be larger than the average power level of the traffic signals 410/420.

Because the power required by the auxiliary reference signals 540a/540b to pre-cancel interference is reduced (as described above), the pulse power of the first reference signal 530 can be increased without impacting the PAPR of the waveform. That is, the total power level at potential signal component time p as a result of the primary reference signal 530 power level and the power levels of the auxiliary reference signals 540a/540b can still be limited to (i.e. equal to or less than) a peak power associated with the data signals 410/420 in the second set of signal outputs 500 while boosting the power of the primary reference signal 530. This may allow the power level of the first reference signal 530 to be optimized to provide improved channel performance (e.g. to enhance the performance of phase-noise estimation) while maintaining low PAPR.

The precise level of the power boost that may be provided to a primary reference signal 530 may depend on the filter used by the transmitting device. However, it is expected that the power boost for a primary reference signal 530 can be larger than 1 dB for existing filters, although increased power boost levels may be achievable by future generation filters. This may allow the power level of the primary reference signal to be 1 dB (or more) greater than the average power level of the traffic signals 410/420.

The set of signal outputs 500 can also include a plurality of traffic signal components. As with the example shown in FIG. 5, the plurality of traffic signal components can include a sequence of alternating real traffic signal pulses 410 and imaginary traffic signal pulses 420. The traffic signal pulses 410/420 can be defined to transmit data to a receiver. However, the traffic signal pulses 420 (particularly the traffic signal component 420a at potential signal component time p−3 and the traffic signal component 420c at potential signal component time p+3) may cause interference with the first reference signal 530.

In the example illustrated in FIG. 6, the first reference signal 530 is a real reference signal that replaces a real data traffic signal component (i.e. the first reference signal 530 is a real reference signal located at a potential signal component time p that would otherwise be used to transmit a real traffic signal component). Alternately, where the first reference signal 530 is located at a potential signal component time that would otherwise be used to transmit an imaginary traffic signal component (e.g. where the data signals 410 are imaginary traffic signals and the data signals 420 are real traffic signals), the first reference signal 530 is an imaginary reference signal that replaces an imaginary data traffic signal component.

In the example illustrated, the second reference signal (i.e. first auxiliary reference signal) 540b is an imaginary reference signal that replaces an imaginary data traffic signal component (i.e. the second reference signal 540b is an imaginary reference signal located at a potential signal component time p−1 that would otherwise be used to transmit an imaginary traffic signal component). Alternately, where the second reference signal 540b is located at a potential signal component time that would otherwise be used to transmit a real traffic signal component (e.g. where the data signals 410 are imaginary traffic signals and the data signals 420 are real traffic signals), the second reference signal 540b is a real reference signal that replaces a real data traffic signal component.

In the example illustrated, the third reference signal (i.e. second auxiliary reference signal) 540a is an imaginary reference signal that replaces an imaginary data traffic signal component (i.e. the third reference signal 540a is an imaginary reference signal located at a potential signal component time p+1 that would otherwise be used to transmit an imaginary traffic signal component). Alternately, where the third reference signal 540a is located at a potential signal component time that would otherwise be used to transmit a real traffic signal component (e.g. where the data signals 410 are imaginary traffic signals and the data signals 420 are real traffic signals), the third reference signal 540a is a real reference signal that replaces a real data traffic signal component.

As noted, the interference from data signals 420 to the primary reference signal 530 can be pre-cancelled by the auxiliary reference signals 540a/540b. However, the primary reference signal 530 may also introduce some interference to the data signals 410/420. In the example shown in FIG. 6, however, the primary reference signal 530 is spaced apart from data signals 410 by the Nyquist rate and thus does not cause interference with data signals 410. In addition, the primary reference signal 530 is a real signal while the data signals 420 are imaginary traffics signals. Thus, the real interference from the primary reference signal 530 to the imaginary data signals 420 can be disregarded by the receiver.

As noted above, the first reference signal 530 may be defined as a pilot symbol usable for channel estimation. For example, the first reference signal 530 may be a phase tracking reference signal used for estimating the phase distortion of a communication channel. Alternately or in addition, the first reference signal 530 may be used to estimate phase and amplitude-related measurements of a communication channel.

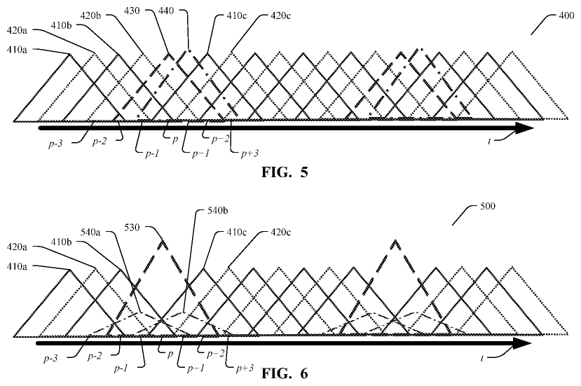

Referring to FIG. 7, shown therein is a third set of signal outputs 600. The third set of signal outputs 600 illustrates an example of a second reference signal configuration in accordance with a second embodiment. The second reference signal configuration may be particularly suited to use in communication systems requiring low PAPR waveforms, such as communication systems using SC-OQAM.

While amplitude fluctuations in a primary reference signal affect the signal to noise ratio (SNR) of the estimated phase, the amplitude fluctuations do not distort the phase per se. Accordingly, to the primary reference signal may be configured to simplify the transmitter/receiver operation while minimizing the impact of residual data interference on the primary reference signal.

As with the first set of signal outputs 400 and the second set of signal outputs 500, the third set of signal outputs 600 is also illustrated over a time interval t. The third set of signal outputs 600 is generally similar to the second set of signal outputs 500 shown in FIG. 6 with the exception of the signal pulses transmitted at p−1, p, and p+1.

As shown in FIG. 7, the set of signal outputs 600 can also include a first reference signal 630. The primary reference signal 630 can be configured to provide a receiver with information relating to the channel between the transmitter and the receiver. For example, the first reference signal 630 may be defined as a pilot symbol usable for channel estimation. The first reference signal 630 can be defined using configuration parameters exchanged between the transmitter and the receiver. As illustrated, the primary reference signal 630 is transmitted at a time p (i.e. at a potential signal component time p).

However, in the example shown in FIG. 7 (unlike the first set of signal outputs 500 and the second set of signal outputs 600) the first reference signal 630 is sent as a flipped real/imaginary signal (i.e. the first reference signal 630 is flipped from a real-valued symbol to an imaginary-valued symbol or the first reference signal 630 is flipped from an imaginary-valued symbol to a real-valued symbol). That is, the first reference signal 630 is flipped real/imaginary as compared to the expected data signal for potential signal component time p.

In the example illustrated, the primary reference signal 630 is transmitted as an imaginary reference signal that replaces a real data traffic signal component (i.e. the first reference signal 630 is an imaginary reference signal located at a potential signal component time p that would otherwise be used to transmit a real traffic signal component). Alternately, the first reference signal 630 may be transmitted as a real reference signal that replaces an imaginary data traffic signal component (i.e. the first reference signal 630 may be a real reference signal located at a potential signal component time p that would otherwise be used to transmit an imaginary traffic signal component).

In effect, flipping the first reference signal 630 from real to imaginary (or imaginary to real) converts phase distorting interference from surrounding data signals into variations in the signal-to-noise ratio (SNR) of the signal waveform. For instance, the variation in the SNR caused by the data interference may be about ±1 dB around the original SNR.

If the first reference signal sent at p were not flipped, the interference from the data signals at p±3 may cause about 0.122 radian (e.g. 7.0°) in phase distortion. However, due to the flipping of the first reference signal 630, the interference from the data at p±3 is reflected in the SNR of the signal pulse, rather than phase distortion. Accordingly, the SNR of the first reference signal pulse will fluctuate between −1.1 dB to +1.0 dB around the original PT-RS power. Accordingly, embodiments in which the first reference signal is flipped between real and imaginary may be preferred in operating conditions with a large signal to noise ratio.

The set of signal outputs 600 can also include a plurality of traffic signal components. As with the example shown in FIG. 6, the plurality of traffic signal components can include a sequence of alternating real traffic signal pulses 410 and imaginary traffic signal pulses 420. The traffic signal pulses 410/420 can be defined to transmit data to a receiver. However, the traffic signal pulses 420 (particularly the traffic signal component 420a at potential signal component time p−3 and the traffic signal component 420c at potential signal component time p+3) may cause interference with the first reference signal 630.

As noted above, there will be mutual interference between the first reference signal 630a and the nearby data signals. In the set of signal outputs 600, the nearest interference from data to the first reference signal 630 is from the imaginary traffic signal component 420a at potential signal component time p−3 and the imaginary traffic signal component 420c at potential signal component time p+3. The data signals 410 do not cause interference to the primary reference signal 630 in the example illustrated. Referring back to the interference response shown in Table 1, the combined interference from p±3 is ±0.134 unit.

By flipping the first reference signal 630 from real to imaginary (or imaginary to real), the interference from surrounding data (e.g. the imaginary traffic signal component 420a at potential signal component time p−3 and the imaginary traffic signal component 420c at potential signal component time p+3) is of the same phase. As a result, the interference from the traffic signal components 420 to the first reference signal 630 does not distort the estimated phase. Where the first reference signal 630 is used for phase estimation, the third set of signal outputs can provide increased resiliency against residual data interference.

Flipping the first reference signal 630 from real to imaginary (or imaginary to real) may also simplify the signal processing required to be performed by the transmitting device. For instance, the set of signal outputs 600 may no longer require interference pre-cancellation. This may be particularly useful in applications where small amplitude variations are less likely to degrade the ability to read the signal at the receiver end.

As shown in the example of FIG. 7, the set of signal outputs 600 may also omit auxiliary reference signals. This may simplify the signal processing required by the transmitter, as no interference pre-cancellation is needed. However, due to interference from the data signals (e.g. the imaginary traffic signal component 420a at potential signal component time p−3 and the imaginary traffic signal component 420c at potential signal component time p+3), the first reference signal 630 in the set of signal outputs 600 cannot be used for amplitude estimation. Rather, the first reference signal 630 may be limited to providing phase tracking data for the communication channel. Thus, the primary reference signal 630 may be defined as a phase tracking reference signal used for estimating the phase distortion of a communication channel.

As shown in the example of FIG. 7, the set of signal outputs 600 may omit any signal components at potential signal component times p±1. Accordingly, the pulse power allocated to the first reference signal 630 can be increased (even further as compared to the example shown in FIG. 6) without affecting the PAPR of the signal waveform. Given the omission of any signals at p±1, the pulse power of the first reference signal 630 can be increased without affecting the PAPR of the signal waveform.

The pulse power of the first reference signal 630 may also be increased to be equal to, or greater than, the pulse power of the data signals in the third set of signal outputs 600. For example, the pulse power of the first reference signal 630 may be larger than or equal to the pulse power of the traffic signal 410a (in this example, a real traffic signal) and/or the pulse power of the traffic signal 420a (in this example, an imaginary traffic signal) and/or the pulse power of the traffic signal 410b (in this example, a real traffic signal) and/or the pulse power of the traffic signal 410c (in this example, a real traffic signal) and/or the pulse power of the traffic signal 420c (in this example, an imaginary traffic signal). In some examples, the pulse power of the first reference signal 630 may be larger than the average power level of the traffic signals 410/420.

It should also be noted that the first reference signal 630 will cause interference to the nearby data signals. That is, the first reference signal 630 will affect the amplitude but not phase of the nearby traffic signals (typically by less than ±0.5 dB). However, the first reference signal 630 can be determined prior to data transmission. Accordingly, the interferences from the first reference signal 630 to the nearby traffic signals can be pre-calculated and compensated for prior to transmission. Additionally, the density of the primary reference signal 630 tends to be much lower than the density of data signals 410/420, which reduces the impact of the interference from the primary reference signals 630. In some cases, interference pre-compensation may not even be required (e.g. for low code rate QPSK data), which may further simplify the overall signal processing operation.

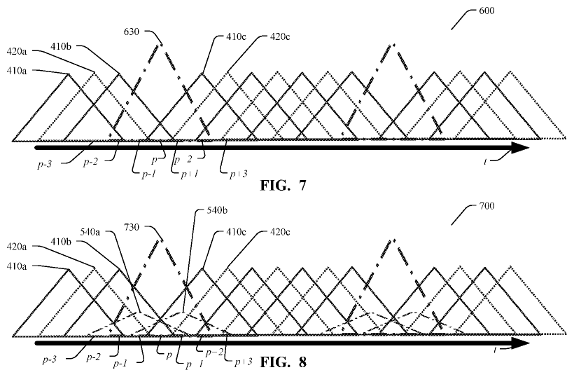

Referring to FIG. 8, shown therein is a fourth set of signal outputs 700. The fourth set of signal outputs 700 illustrates an example of a third reference signal configuration in accordance with a third embodiment. The third reference signal configuration may be particularly suited to use in communication systems requiring low PAPR waveforms, such as communication systems using SC-OQAM.

As with the first set of signal outputs 400, second set of signal outputs 500, and third set of signal outputs 600, the fourth set of signal outputs 700 are also illustrated over a time interval t. As shown in FIG. 8, the fourth set of signal outputs 700 includes a first reference signal 730 at potential signal component time p.

The primary reference signal 730 is generally analogous to the primary reference signal 630 of the third set of signal outputs 600. That is, the first reference signal 730 has been flipped from real to imaginary (or imaginary to real) in the same manner as with the third set of signal outputs 600. This can provide the third reference signal configuration with increased resiliency against residual data interference. However, unlike the third set of signal outputs 600, the fourth set of signal outputs 700 also includes auxiliary reference signals in the form of second reference signal 540b and a third reference signal 540a (similar to the first configuration shown in FIG. 6) that can be used to pre-cancel interference from nearby data signals. Accordingly, the primary reference signal 730 may provide additional measurement data beyond simply phase distortion data.

For example, the primary reference signal 730 may be used to estimate phase and amplitude-related measurements of a communication channel. Alternately or in addition, the primary reference signal 730 may be a phase tracking reference signal used for estimating the phase distortion of a communication channel.

As explained above with reference to FIG. 6, the second reference signal 540b and third reference signal 540a can be defined to pre-cancel interference from the data signals (e.g. the imaginary traffic signal component 420a at potential signal component time p−3 and the imaginary traffic signal component 420c at potential signal component time p+3) to the first reference signal 730. The first reference signal 730 may thus be able to provide additional measurement data relating to the communication channel.

The transmitter can be configured to determine expected traffic signal interference between the plurality of traffic signal components 410/420 and the primary reference signal 730. In the example illustrated, only traffic signal components 420 cause interference to the primary reference signal 730. The transmitter can then define the auxiliary reference signals 540a/540b as a pair of pre-cancellation signal components determined to cancel the expected traffic signal interference for the primary reference signal 730.

The interference between the traffic signal components and the first reference signal 730 can be determined by the transmitter prior to transmission. Accordingly, the interference cancellation can be pre-calculated in order to determine the second reference signal 540b and third reference signal 540a Similar to the configuration shown in FIG. 6, the power required by the second reference signal 540b and third reference signal 540a may be reduced due to the omission of a data signal at p+1 and p−1, as well as spreading the interference pre-cancellation requirement across two auxiliary reference signals. Accordingly, the pulse power of the first reference signal 730 can again be increased without impacting the PAPR of the overall waveform.

The pulse power of the first reference signal 730 may also be increased to be equal to, or greater than, the pulse power of the data signals in the fourth set of signal outputs 700. For example, the pulse power of the first reference signal 730 may be larger than or equal to the pulse power of the traffic signal 410a (in this example, a real traffic signal) and/or the pulse power of the traffic signal 420a (in this example, an imaginary traffic signal) and/or the pulse power of the traffic signal 410b (in this example, a real traffic signal) and/or the pulse power of the traffic signal 410c (in this example, a real traffic signal) and/or the pulse power of the traffic signal 420c (in this example, an imaginary traffic signal). In some examples, the pulse power of the first reference signal 730 may be larger than the average power level of the traffic signals 410/420.

Additionally, the third configuration may be further resilient to residual interference from data signals 420, by transforming phase distortion to small SNR variations of the primary reference signal 730.

In various embodiments described herein, the primary reference signals (e.g. first reference signals 530, 630, and 730) can be used to provide different types of measurements. In some cases, the primary reference signal may be defined based on measurements related to phase only, such as measurements of phase noise and phase compensation. For example, reference signal configurations in which auxiliary reference signals are omitted (such as the second configuration illustrated by FIG. 7) may be limited to measurements related to phase only.

In some cases, the primary reference signals may be defined based on measurements related to both phase and amplitude. For example, reference signal configurations in which auxiliary reference signals are used (such as first and third configurations illustrated by FIGS. 6 and 8 respectively) may be defined based on measurements related to phase only and/or measurements related to both phase and amplitude.

Examples of measurements related to both phase and amplitude include channel acquisition measurements such as CSI (channel state information), demodulation measurements, beam management measurements (beam failure detection and mobility handling for example), radio link monitoring measurements (including path-loss estimation for example).

The selection of reference signal type and the configuration of a particular primary reference signal may depend on various configuration factors, such as the device capabilities of the transmitter and/or receiver (e.g. the interference pre-cancellation capability), interference cancelation requirements (which may be related to service/traffic type such as packet size, QoS requirement, required SNR operation range, modulation level), reference signal measurement type and so forth.

Referring to FIG. 9, shown therein is an example communication method 750. Communication method 750 is an example process that may be used by communication devices to transmit a set of signal outputs that includes one or more reference signals. The example communication method 750 may be performed by communication devices using examples of the reference signal configurations described herein. Communication method 750 may be performed by various communication devices such as a user equipment, a base station, other type of TRP, or other type of communication device. In general, the communication device can include one or more units using hardware, software, firmware or any combination thereof. For example, the communication device may include a processing unit (e.g. a processor) and a transmitting unit (e.g. a transmitter or transceiver).

At 755, the communication device can obtain one or more reference signal parameters including a first reference signal configuration parameter. In some cases, the first reference signal configuration parameter may be received by the communication device. An example process for obtaining the first reference signal configuration parameter is described in further detail herein below with reference to step 820 of method 800.

The first reference signal configuration parameter may be received from a different device in communication with the communication device (examples of which are described herein below with reference to step 820 of method 800 and step 920 of method 900). For example, the first reference signal configuration parameter may be transmitted by a different device using established signaling parameters (an example of which is described with reference to step 840 of method 800).

In some cases, the communication device may be configured to transmit a transmitter interference pre-cancellation capability signal prior to receiving the first reference signal configuration parameter (an example of which is described with reference to step 910 of method 900 described below). For example, where the communication device is user equipment, the user equipment may transmit a configuration, for an example, the transmitter interference pre-cancellation capability information to a different device (e.g. a base station). The different device may determine the first reference signal configuration parameter using the transmitter interference pre-cancellation capability information from the communication device (an example of which is described with reference to step 820 of method 800 described below). This different device may then transmit the first reference signal configuration parameter to the communication device.

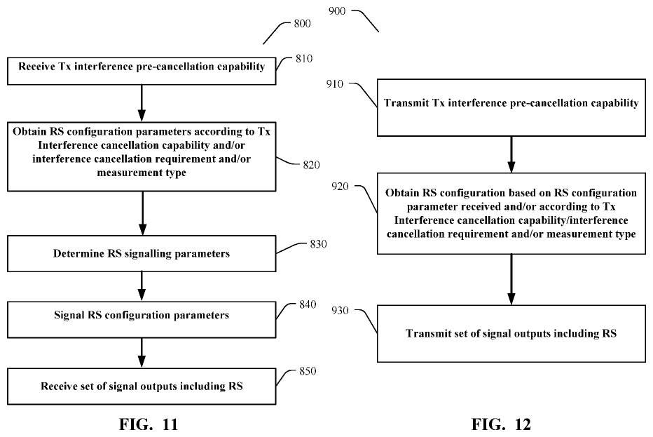

In some cases, the communication device may be configured to determine the first reference signal configuration parameter based on one or more operational characteristics for a communication channel and/or communication device. The one or more operational characteristics may be used to identify the type and/or characteristics of a reference signal configuration (examples of which are described with reference to step 820 in FIG. 11, step 920 in FIG. 12 and step 1010 in FIG. 13 described below). For example, the one or more operational characteristics may include a transmitter interference pre-cancellation capability and/or an interference cancellation requirement and/or a reference signal measurement type.

In examples where the one or more operational characteristics include a transmitter interference pre-cancellation capability, the communication device may receive a transmitter interference pre-cancellation capability signal indicating the transmitter interference pre-cancellation capability prior to determining the first reference signal configuration parameter (an example of which is described with reference to step 810 of method 800).

At 760, one or more reference signals can be defined based on the first reference signal configuration parameter. In some cases, the one or more reference signals may be defined to include only a primary reference signal based on the first reference signal configuration parameter (as in the example reference signal configuration shown in FIG. 7). Alternately, the one or more reference may be defined to include a primary reference signal and at least two auxiliary reference signals based on the first reference signal configuration parameter (as in the example reference signal configurations shown in FIGS. 6 and 8).

In some cases, the first reference signal configuration parameter may specify that the primary reference signal be defined as a phase tracking reference signal. The phase tracking signal can be defined to be usable for estimating the phase distortion of a communication channel.

In some cases, the first reference signal configuration parameter may specify that the primary reference signal be defined based on both phase and amplitude related measurements. The primary reference signal may be defined to be usable to estimate phase and amplitude-related measurements of a communication channel.

Characteristics of the reference signals can also be defined based on the reference signal configuration parameter. For example, the pulse power of the reference signals can be defined based on the reference signal configuration parameter defined at 755.

At 765, a set of signal outputs can be transmitted by the communication device. The set of signal outputs can include a first reference signal at a time p. The first reference signal can be the primary reference signal defined at 760.

The set of signal outputs may be defined based an alternating pattern of real signal components and imaginary signal components. For instance, the set of signal outputs may include a plurality of potential signal component times (e.g. p−3, p−2, p−1, p, p+1, p+2, p+3 . . . ) that are equally spaced apart in time. The plurality of potential signal component times can be defined with an alternating pattern of potential real signal component times and potential imaginary signal component times. The potential real signal component times may correspond to signal component times when a real data signal would be transmitted. The potential imaginary signal component times may correspond to signal component times when an imaginary data signal would be transmitted.

In some examples, the first reference signal can be defined as a real reference signal transmitted at a potential real signal component time. In this case, the first reference signal may be considered a real reference signal replacing real traffic at time p. For example, the set of reference signals can include a first real traffic signal transmitted at a time p−2 and a second real traffic signal transmitted at a time p+2. The first reference signal may be defined at 760 to be a real reference signal (e.g. in the example reference signal configuration shown in FIG. 6).

In some examples, the first reference signal can be defined as an imaginary reference signal transmitted at a potential imaginary signal component time. In this case, the first reference signal may be considered an imaginary reference signal replacing imaginary traffic at time p. For example, the set of reference signals can include a first imaginary traffic signal transmitted at a time p−2 and a second imaginary traffic signal transmitted at a time p+2. The first reference signal may then be defined at 760 to be an imaginary reference signal (e.g. in the example reference signal configuration shown in FIG. 6).

Alternately, the first reference signal may be a flipped reference signal. In some examples, the first reference signal can be defined as a real reference signal transmitted at a potential imaginary signal component time. In this case, the first reference signal may be considered a first real reference signal replacing imaginary traffic at time p. For example, where the first reference signal is the first real reference signal, the set of signal outputs may include a first imaginary traffic signal transmitted at the time p−2 and a second imaginary traffic signal transmitted at the time p+2.

In some examples, the first reference signal can be defined as an imaginary reference signal transmitted at a potential real signal component time. In this case, the first reference signal may be considered a first imaginary reference signal replacing real traffic at time p. For example, where the first reference signal is the first imaginary reference signal, the set of signal outputs may include a first real traffic signal transmitted at a time p−2 and a second real traffic signal transmitted at a time p+2.

In some examples, the set of signal outputs may include a second reference signal transmitted at a time p+1 and a third reference signal transmitted at a time p−1. The second reference signal and the third reference signal can be defined to pre-cancel interference from traffic to the first reference signal. For example, where the first reference signal is not flipped, the set of signal outputs will include the second reference signal and the third reference signal.

The second reference signal and the third reference signal may be optional when the first reference signal is flipped. In some examples, the set of signal outputs may include a second reference signal transmitted at a time p+1 and a third reference signal transmitted at a time p−1 when the first reference signal is a flipped reference signal. Alternately, when the first reference signal is a flipped reference signal, the set of signal outputs may omit any signal pulses at a time p−1 and a time p+1.

In some examples, the second reference signal may be a second real reference signal at time p+1 and the third reference signal may be a third real reference signal at time p−1. In these examples, the second reference signal can be defined to replace real traffic at time p+1 and the third reference signal can be defined to replace real traffic at time p−1.

In some examples, the second reference signal may be a second imaginary reference signal at time p+1 and the third reference signal is a third imaginary reference signal at time p−1. In these examples, the second reference signal can be defined to replace imaginary traffic at time p+1 and the third reference signal can be defined to replace imaginary traffic at time p−1.

Optionally, the pulse power of the first reference signal may be increased to improve channel estimation while maintaining a low PAPR signal. For example, the pulse power of the first reference signal may be larger than the pulse power of the second reference signal and the pulse power of the third reference signal. Alternately or in addition, the pulse power of the first reference signal may larger than or equal to any one of the pulse power of the first real traffic signal and/or the pulse power of the second real traffic signal and/or the pulse power of the first imaginary traffic signal and/or the pulse power of the second imaginary traffic signal.

Optionally, the pulse power of the second reference signal and/or the pulse power of the third reference signal may be reduced to ensure that a low PAPR can be maintained. For example, any one of the pulse power of the second reference signal and the pulse power of the third reference signal may smaller than the pulse power of the first real traffic signal and/or the pulse power of the second real traffic signal and/or the pulse power of the first imaginary traffic signal and/or the pulse power of the second imaginary traffic signal.

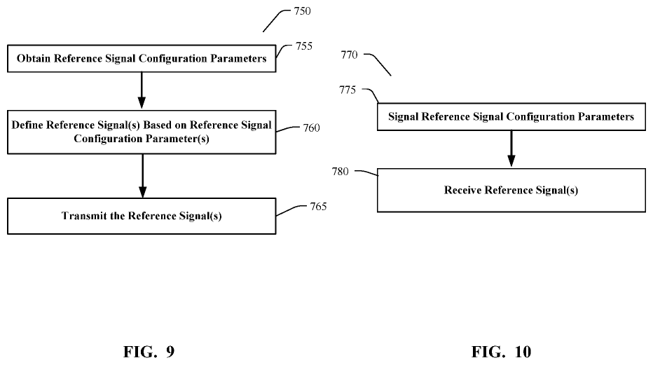

Referring to FIG. 10, shown therein is an example communication method 770. Communication method 770 is an example process that may be used by communication devices to receive one or more reference signals. The example communication method 770 may be performed by communication devices using examples of the reference signal configurations described herein. Communication method 770 may be performed by various communication devices such as a user equipment, a base station, other type of TRP, or other type of communication device. In general, the communication device can include one or more units using hardware, software, firmware or any combination thereof. For example, the communication device may include a processing unit (e.g. a processor) and a transmitting unit (e.g. a transmitter or transceiver).

At 775, the communication device may signal a first reference signal configuration parameter to a transmitting device. The communication device can transmit the reference signal configuration parameters to the transmitting device various established signaling parameters, and example of which is described in further detail herein below with reference to step 840 of method 800.

In some cases, the communication device can perform a step of obtaining one or more reference signal parameters including a first reference signal configuration parameter prior to signaling the first reference signal configuration parameter. The communication device may obtain the reference signal parameters in various ways, as described in further detail herein above with reference to step 755 of method 750.

At 780, the communication device can receive a set of signals including one or more reference signals. The reference signal(s) can be defined according to the various example reference signal configurations described herein above with reference to FIGS. 6 to 8 (see also step 760 of method 750). For example, the one or more reference signals may be defined to include only a primary reference signal based on the first reference signal configuration parameter (as in the example reference signal configuration shown in FIG. 7). Alternately, the one or more reference may be defined to include a primary reference signal and at least two auxiliary reference signals based on the first reference signal configuration parameter (as in the example reference signal configurations shown in FIGS. 6 and 8).

The communication device may identify the one or more reference signals using the first reference signal configuration parameter obtained at 775. The communication device may also use the first reference signal configuration parameter obtained at 775 to interpret the reference signals.

The communication device may evaluate the received reference signals to determine characteristics of the channel between a transmitting device and the communication device. For example, the communication device may perform channel estimation based on evaluating a primary reference signal received at 780 as part of the one or more reference signals.

The first reference signal configuration parameter obtained at 775 may indicate to the communication device the characteristics (e.g. amplitude and phase) of the primary reference signal being transmitted. The communication device may then evaluate the received primary reference signal to detect changes in the expected characteristics (e.g. attenuation and/or phase distortion). The detected changes can be used to estimate the channel response between the transmitting device and the communicating device. The communication device can then adjust data signals received from the transmitting device to compensate for the estimated channel response.

FIGS. 11 and 12 illustrate a first example of a communication processes performed by communication devices using examples of the reference signal configurations described herein. In particular, FIG. 11 illustrates an example process 800 performed by a first communication device (e.g. a base station or other type of TRP or communication device) in obtaining a first reference signal parameter, communicating the first reference signal parameter to a second communication device (e.g. user equipment) in communication with the first communication device, and receiving a set of signal outputs including a first reference signal from the second communication device. FIG. 12 illustrates an example of a corresponding process 900 performed by the second communication device in obtaining the first reference signal parameter, and transmitting the set of signal outputs including the first reference signal to the first communication device.

Referring now to FIG. 11, shown therein is an example communication process 800 that may be implemented using various reference signal configurations, such as the configurations of reference signals 530, 630 and 730 described herein above. The process 800 shown in FIG. 11 may be performed by a first communication device which may be provided by various data communication devices, such as a base station (e.g. a T-TRP 170) or other types of TRPs or communication devices for example. For simplicity, the process 800 is described in the context of a T-TRP 170 in the form of a base station operating as the first communication device and operations performed by the at least one transmitter 252, at least one receiver 254, and processor 260.

Optionally, at 810, the transmitter interference pre-cancellation capability of a second communication device can be obtained by the first communication device (e.g. the base station). The transmitter interference pre-cancellation capability can define the level of interference pre-cancellation that can be performed by the second communication device. The second device in communication with the base station may be a user equipment, for example (see e.g. step 910 of process 900 described herein below). The second device may be configured (through process 900 described herein below) to transmit a primary reference signal to the base station.

At 820, a first reference signal parameter (referred to herein as the RS configuration parameters) may be obtained by the processor 260. The first reference signal parameter may define the characteristics (e.g. type and configuration) of a primary reference signal. In some examples, the first communication device may obtain the first reference signal parameter by determining the first reference signal parameter based on various operational characteristics and/or requirements of the communication channel, the first communication device and/or the second communication device.

Alternately, the first communication device may obtain the first reference signal parameter by receiving the first reference signal parameter from another communication device, such as the second communication device. In some examples, receiving the first reference signal parameter may include receiving an explicit indication of the first reference signal parameter from the second communication device (e.g. the user equipment). Alternately, receiving the first reference signal may include receiving an indication of the capabilities of the second communication device (e.g. the capability received at 810 from the second communication device) that are at least partially determinative of the first reference signal parameter.

In some examples, the first reference signal parameter may be determined based on a default reference signal configuration. This may allow communication devices to begin communication without requiring any signaling of the first reference signal parameter between the devices. Depending on the particular implementation of a communication system or process, the default reference signal configuration may vary. For example, the default reference signal configuration may be selected as the reference signal configuration that omits interference pre-cancellation (e.g. the example configuration shown in FIG. 7) to ensure compatibility with a wider arrays of devices, including devices lacking pre-cancellation capabilities. Alternately, the default reference signal configuration may be selected as a reference signal configuration that includes interference pre-cancellation (e.g. the example configurations shown in FIGS. 6 and 8) to allow additional measurements to be performed on the primary reference signal.

In some examples, the first reference signal parameter may be selected from a set of pre-defined configurations. The particular pre-defined configuration may be selected based on one or more operational requirements and/or operational characteristics for a communication channel and/or a communication device.

The first reference signal parameter may specify a reference signal type for the one or more reference signals. As noted above, the reference signal type may be selected based on various configuration parameters, such as the transmitter interference pre-cancellation capability (e.g. the capability received at 810 from the second communication device), the interference cancellation requirements of the communication channel, and/or the measurement type required for the communication channel.

For example, where the second communication device lacks interference pre-cancellation capacity, only the second reference signal configuration may be possible (i.e. the reference signal configuration illustrated in FIG. 7). However, where the second communication device is capable of interference pre-cancellation, the selection of the primary reference signal configuration may rely on other configuration parameters.

Where both phase and amplitude data is required for the primary reference signal, either the first or third reference signal configuration may be used (e.g. the reference signal configurations shown in FIGS. 6 and 8). As noted above, the second configuration of the reference signals is not suitable for transmitting amplitude related measurements. The first and third configuration of the reference signal involve auxiliary reference signals used for interference pre-cancellation. Accordingly, these configurations require communication between devices with interference pre-cancellation capacity.

In some examples, the third configuration may be preferred over the first configuration. For example, communication channels operating with higher modulation levels and/or requiring a higher quality of service may prefer the third configuration as it provides increased resiliency to residual data interference.

Where only phase data is required for the reference signal, any of the first, second or third configurations may be used (e.g. the reference signal configurations shown in FIGS. 6-8). However, the reference signal configuration used in the second embodiment may be preferred where reducing the signal processing requirements for the transmitter device is desired. This may further enable communication with a low-cost transmitter device that does not provide pre-cancellation capacity. The reference signal configuration used in the second embodiment may also be preferred for communication systems using lower modulation, such as QPSK modulation for example.

Optionally, at 830, the base station can determine reference signal signaling parameters. The reference signal signaling parameters can be used to signal to the second communication device the configuration of the reference signal obtained at 820. It should be understood that steps 820 and 830 may be performed concurrently and/or consecutively in different implementations of method 800.

The base station can be configured to determine the signaling parameters for various aspects of the reference signal configuration, such as the reference signal type, the reference signal density (in time domain and frequency domain), and any power boost for the reference signal.

In some cases, the reference signal type may be signaled using standard communication protocols such as the Radio Resource Control (RRC) protocol. Alternately or in addition, the reference signal type may be signaled based on a predefined association with measurement type, device capability, service type, modulation level etc.

The reference signal density can also be signaled using standard communication protocols, such as RRC and/or a downlink control indicator (DCI), and/or a combination of RRC and DCI.

Similarly, the power boost level of the reference signal can be also signaled using standard communication protocols such as RRC or DCI or other signaling techniques. In some cases, the power boost level of the reference signal need not be communicated. For example, where the reference signal relates only to phase data, the amplitude of the reference signal need not be determined precisely and so the power boost level may be omitted. In alternative implementations, where the reference signal type includes amplitude related measurements, the power boost level must be communication to ensure proper interpretation of the reference signal by the receiving device.

At 840, the base station can signal the RS configuration parameters to the second communication device. The base station can transmit the RS configuration parameters to the second communication device using the signaling parameters determined at 830. Alternately, the base station can transmit the RS configuration parameters to the second communication device using pre-established communication protocols between the first communication device and the second communication device.

The RS configuration parameters can then be used by the second communication device to configure the primary reference signal for transmission to the base station (see e.g. step 920 described below). Signaling the RS configuration parameters can ensure that both communication devices are aware of the expected configuration of the primary reference signal. The primary reference signal transmitted to the base station by the second communication device can thus be configured in a manner that is detectable by the base station, and subsequently usable to perform channel estimation.

At 850, the base station can receive a set of signal outputs. The set of signal outputs can be received from the second communication device. The set of signal outputs can include one or more reference signals including a first reference signal. The one or more reference signals may be defined according to the RS configuration parameters signaled to the second communication device at 840.

The reference signal(s) can be defined according to the various example reference signal configurations described herein above with reference to FIGS. 6 to 8 (as described with reference to step 760 of method 750). For example, the one or more reference signals may be defined to include only a primary reference signal based on the first reference signal configuration parameter (as in the example reference signal configuration shown in FIG. 7). Alternately, the one or more reference may be defined to include a primary reference signal and at least two auxiliary reference signals based on the first reference signal configuration parameter (as in the example reference signal configurations shown in FIGS. 6 and 8).

Referring now to FIG. 12, shown therein is an example communication process 900 that may be implemented using various reference signal configurations, such as the configurations of reference signals 530, 630 and 730 described herein above. The process 900 shown in FIG. 12 may be performed by a second communication device which may be provided by various data communication devices, such as user equipment (e.g. an ED 110) for example. For simplicity, the process 900 is described in the context of an ED 110 operating as the second communication device and operations performed by the transmitter 201, receiver 203, and processor 210.

Optionally, at 910, the transmitter 201 can transmit the interference pre-cancellation capability of the ED 110 to the base station. The interference pre-cancellation capability can define the level of interference pre-cancellation that can be performed by the ED 110. The interference pre-cancellation capability of the ED 110 can vary depending on the specific nature of the ED 110 and its signal processing capabilities.

At 920, the user equipment can obtain the configuration of a primary reference signal to be sent by that user equipment. The user equipment may obtain the configuration of the primary reference signal in various ways. In some cases, the user equipment may obtain the configuration of the primary reference signal by determining the configuration directly, e.g. in the same manner as described above in relation to the base station at 820. Alternately or in addition, the user equipment may obtain the configuration of the reference signal by receiving a first reference signal parameter from a first communication device. For example, the first reference signal parameter may be obtained based on signaling parameters received from a first device in communication with the user equipment such as a base station (e.g. the configuration parameters transmitted by the base station at 840).

At 930, the user equipment can transmit a set of signal outputs. The set of signal outputs can include one or more reference signals including a primary reference signal. The primary reference signal can be transmitted to the first device in communication with the user equipment. The primary reference signal can be transmitted as part of a set of signal outputs, such as those shown in FIGS. 6-8 described herein above. For example, the primary reference signal may be transmitted in the form of a primary reference signal 530, 630 or 730. In some examples, the set of signal outputs may also include a second reference signal (e.g. 540b) and a third reference signal (e.g. 540a). The base station receiver can then use the primary reference signal to perform channel estimation.

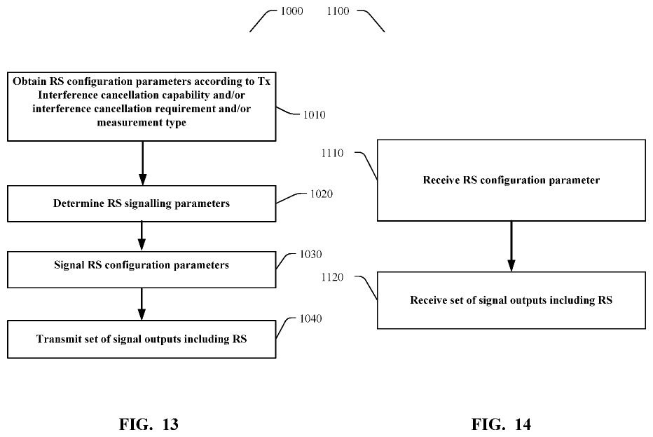

FIGS. 13 and 14 illustrate a second example of a communication processes that may be performed by communication devices using various examples of the reference signal configurations (e.g. the configurations of reference signals 530, 630 and 730) described herein. In particular, FIG. 13 illustrates an example process 1000 performed by a first communication device (e.g. a base station or other type of TRP) in obtaining reference signal configuration parameters, transmitting the reference signal configuration parameters to a second communication device (e.g. user equipment) in communication with the first communication device, and transmitting one or more reference signals to the second communication device. FIG. 14 illustrates a corresponding process 1100 performed by the second communication device to receive the reference signal configuration parameters and receive the one or more reference signals transmitted by the first communication device.

Referring now to FIG. 13, shown therein is an example communication process 1000 for configuring and transmitting a reference signal, that may be implemented using various reference signal configurations, such as the configurations of the reference signals 530, 630 and 730 described herein above. The process 1000 shown in FIG. 13 may be performed by a first communication device which may be provided by various data communication devices, such as a base station (e.g. a T-TRP 170) or other types of TRPs or communication devices for example. For simplicity, the process 1000 is described in the context of a T-TRP 170 in the form of a base station operating as the first communication device and operations performed by the at least one transmitter 252, at least one receiver 254, and processor 260.

At 1010, a first reference signal parameter (referred to herein as the RS configuration parameters) may be obtained by the processor 260. The first reference signal parameter may define the characteristics (e.g. type and configuration) of a primary reference signal. Obtaining the first reference signal parameter at 1010 can be performed by the processor 260 in generally the same manner as described above at step 820 of method 800 and step 755 of method 750.

In some examples, the first communication device may obtain the first reference signal parameter by determining the first reference signal parameter based on various operational characteristics and/or requirements of the communication channel, the first communication device and/or the second communication device. Alternately, the first communication device may obtain the first reference signal parameter by receiving the first reference signal parameter from another communication device, such as the second communication device.

As noted above, the reference signal type may be selected based on various configuration parameters, such as the transmitter interference pre-cancellation capability of transmitter 252, the interference cancellation requirements of the communication channel, and/or the measurement type required for the communication channel.

Optionally, at 1020 the base station can determine reference signal signaling parameters. The reference signal signaling parameters can be used to signal to the second communication device the configuration of the reference signal obtained at 1010. Determining the reference signal signaling parameters at 1020 can be performed by the processor 260 in generally the same manner as described above at 830. It should be understood that steps 1010 and 1020 may be performed concurrently and/or consecutively in different implementations of method 1000.

At 1030, the base station can signal the RS configuration parameters to the second communication device. The base station can transmit the RS configuration parameters to the second communication device using the signaling parameters determined at 1020. Alternately, the base station can transmit the RS configuration parameters to the second communication device using pre-established communication protocols between the first communication device and the second communication device.

The RS configuration parameters can then be used by the second communication device to detect the primary reference signal in transmissions from the base station (see e.g. step 1120 described below). Signaling the RS configuration parameters can ensure that both communication devices are aware of the expected configuration of the primary reference signal. The primary reference signal transmitted by the base station to the second communication device can thus be configured in a manner that is detectable by the second communication device, and subsequently usable to perform channel estimation.

At 1040, the base station can transmit a set of signal outputs. The set of signal outputs can include one or more reference signals including a primary reference signal. The primary reference signal can be transmitted to the second device (e.g. user equipment) in communication with the base station. The primary reference signal can be transmitted as part of a set of signal outputs, such as those shown in FIGS. 6-8 described herein above. For example, the primary reference signal may be transmitted in the form of a primary reference signal 530, 630 or 730. In some examples, the set of signal outputs may also include a second reference signal (e.g. 540b) and a third reference signal (e.g. 540a). The receiver can then use the primary reference signal to perform channel estimation.

Referring now to FIG. 14, shown therein is an example communication process 1100 for receiving a reference signal, that may be implemented using various reference signal configurations, such as the configurations of the reference signals 530, 630 and 730 described herein above. The process 1100 shown in FIG. 14 may be performed by a second communication device which may be provided by various data communication devices, such as user equipment (e.g. an ED 110) for example. For simplicity, the process 1100 is described in the context of an ED 110 operating as the second communication device and operations performed by the transmitter 201, receiver 203, and processor 210.

At 1110, the user equipment can receive a first reference signal parameter corresponding to the configuration of a primary reference signal to be received by that user equipment. For example, the user equipment can receive the configuration of the reference signal based on signaling parameters received from a first device such as a base station (e.g. the configuration parameters transmitted by the base station at 1030).

At 1120, the user equipment can receive a set of signal outputs. The set of signal outputs can include a primary reference signal received by the user equipment (e.g. the primary reference signal transmitted by the base station at 1040). The user equipment can use the configuration parameters received at 1110 to identify the primary reference signal in the received set of signal outputs. The user equipment may then evaluate the primary reference signal (based on the configuration parameters) in order to perform channel estimation.

As will be apparent to a person of skill in the art, certain adaptations and modifications of the described methods can be made, and the above discussed embodiments of communication systems, devices and processes should be considered to be illustrative and not restrictive.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. In other instances, well-known methods, procedures and components have not been described in detail so as not to obscure the description of the embodiments. Accordingly, what has been described above is intended to be illustrative of the claimed concept and non-limiting. It will be understood by persons skilled in the art that other variants and modifications may be made without departing from the scope of the disclosure as defined in the claims appended hereto. The scope of the claims should not be limited by the preferred embodiments and examples, but should be given the broadest interpretation consistent with the description as a whole.

What is claimed is:

1. A communication method comprising:
obtaining a first reference signal configuration parameter;
transmitting a set of signal outputs, the set of signal outputs including a first reference signal at a time p, wherein the first reference signal is defined based on the first reference signal configuration parameter, wherein the first reference signal is a first real reference signal or a first imaginary reference signal;
wherein the set of signal outputs comprise a second reference signal transmitted at a time p+1, and a third reference signal transmitted at a time p−1.

2. The method of claim 1, wherein the second reference signal is a second real reference signal at time p+1 and the third reference signal is a third real reference signal at time p−1, wherein the second reference signal replaces real traffic at time p+1 and the third reference signal replaces real traffic at time p−1; or
the second reference signal is a second imaginary reference signal at time p+1 and the third reference signal is a third imaginary reference signal at time p−1, wherein the second reference signal replaces imaginary traffic at time p+1 and the third reference signal replaces imaginary traffic at time p−1.

3. The method of claim 1, wherein the second reference signal and the third reference signal are defined to pre-cancel interference from traffic to the first reference signal.

4. The method of claim 1, wherein a pulse power of the first reference signal is larger than a pulse power of the second reference signal and a pulse power of the third reference signal.

5. The method of claim 1, wherein the set of signal outputs comprise a first real traffic signal transmitted at a time p−2 and a second real traffic signal transmitted at a time p+2; or
wherein the set of signal outputs comprise a first imaginary traffic signal transmitted at the time p−2 and a second imaginary traffic signal transmitted at the time p+2.

6. The method of claim 5, wherein the pulse power of the first reference signal is larger than or equal to any one of the following:
the pulse power of the first real traffic signal;
the pulse power of the second real traffic signal;
the pulse power of the first imaginary traffic signal; and
the pulse power of the second imaginary traffic signal.

7. The method of claim 5, wherein any one of the pulse power of the second reference signal and the pulse power of the third reference signal is smaller than any one of the following:
the pulse power of the first real traffic signal;
the pulse power of the second real traffic signal;
the pulse power of the first imaginary traffic signal; and
the pulse power of the second imaginary traffic signal.

8. The method of claim 1, wherein the first reference signal is a phase tracking reference signal usable for estimating the phase distortion of a communication channel.

9. The method of claim 1, wherein the first reference signal is usable to estimate phase and amplitude-related measurements of a communication channel.

10. The method of claim 1, wherein obtaining the first reference signal configuration parameter comprises receiving the first reference signal configuration parameter.

11. The method of claim 10, further comprising:
transmitting a transmitter interference pre-cancellation capability signal prior to receiving the first reference signal configuration parameter.

12. The method of claim 1, wherein obtaining the first reference signal configuration parameter comprises determining the first reference signal configuration parameter based on one or more operational characteristics for a communication channel and/or a communication device.

13. The method of claim 12, wherein the one or more operational characteristics comprises a transmitter interference pre-cancellation capability and/or an interference cancellation requirement and/or a reference signal measurement type.

14. The method of claim 13, wherein the one or more operational characteristics comprise the transmitter interference pre-cancellation capability, and the method further comprises receiving a transmitter interference pre-cancellation capability signal indicating the transmitter interference pre-cancellation capability prior to determining the first reference signal configuration parameter.

15. A communication method comprising:
obtaining a first reference signal configuration parameter;
transmitting a set of signal outputs, the set of signal outputs including a first reference signal at a time p, wherein the first reference signal is defined based on the first reference signal configuration parameter, wherein the first reference signal is a first real reference signal replacing imaginary traffic at time p or a first imaginary reference signal replacing real traffic at time p.

16. The method of claim 15, wherein the first reference signal is the first imaginary reference signal, and the set of signal outputs comprise a first real traffic signal transmitted at a time p−2 and a second real traffic signal transmitted at a time p+2; or
wherein the first reference signal is the first real reference signal, and the set of signal outputs comprise a first imaginary traffic signal transmitted at the time p−2 and a second imaginary traffic signal transmitted at the time p+2.

17. The method of claim 16, wherein the pulse power of the first reference signal is larger than or equal to any one of the following:
the pulse power of the first real traffic signal;
the pulse power of the second real traffic signal;
the pulse power of the first imaginary traffic signal; and
the pulse power of the second imaginary traffic signal.

18. The method of claim 15, wherein the set of signal outputs omits any signal pulses at a time p−1 and a time p+1.

19. The method of claim 15, wherein the first reference signal is a phase tracking reference signal usable for estimating the phase distortion of a communication channel.

20. An apparatus comprising:
at least one processor; and
a non-transitory computer readable storage medium storing processor executable instructions for execution by the processor, the processor executable instructions including instructions to cause the apparatus to:
obtain a first reference signal configuration parameter; and
transmit a set of signal outputs using the transceiver, the set of signal outputs including a first reference signal at a time p, wherein the first reference signal is defined based on the first reference signal configuration parameter, wherein the first reference signal is a first real reference signal or a first imaginary reference signal;
wherein the set of signal outputs comprise a second reference signal transmitted at a time p+1, and a third reference signal transmitted at a time p−1.
